(19) United States
(12) Patent Application Publication
(10) Pub. No.: US 2016/0332350 A1
(43) Pub. Date: Nov. 17, 2016

(54) METHOD FOR MANAGING AN APPARATUS FOR THE INJECTION MOLDING OF PLASTIC MATERIALS

(71) Applicant: INGLASS S.p.A., San Polo di Piave (Treviso) (IT)

(72) Inventors: Maurizio BAZZO, San Polo di Piave (Treviso) (IT); Andrea ZIGANTE, San Polo di Piave (Treviso) (IT)

(21) Appl. No.: 15/149,239

(22) Filed: May 9, 2016

(30) Foreign Application Priority Data
May 11, 2015 (IT) 102015000014572

(51) Int. Cl. B29C 45/76; B29C 45/03; B29C 45/23

(52) U.S. Cl. CPC B29C 45/7613; B29C 45/231; B29C 45/03; B29C 2945/76688; B29C 2945/76521

(57) ABSTRACT

A method for managing an apparatus for the injection molding of plastic materials comprising at least one injector including a pin valve displaceable between a fully closed position and an open position of the injector, an actuator for operating the pin valve of the injector, and an electronic control unit of the actuator. The method provides for the steps of providing an auxiliary power supply and configuring said electronic control unit so as to operate, in case of failure of the mains power supply, an emergency command by virtue of which the pin valve of the injector is positioned in said fully closed position by means of said auxiliary power supply.

### FIELD OF THE INVENTION

The present invention refers to the injection molding of plastic materials into the cavity of a mold, and more in particular it regards a method. for managing a molding apparatus comprising at least one injector including a pin valve displaceable between a position of full closure and an opening position of the injector, an actuator for actuating the pin valve of the injector, and an electronic control unit of the actuator.

### STATE OF THE PRIOR ART

Molding apparatus thus made may include a plurality of injectors whose actuators are controlled by the electronic control unit for example according sequential cycles or in cascade fashion. inc or each actuator may be of the fluid or electrical type, like in the case of document EP-2679374A1 on behalf of the same Applicant, with the advantage of being able to control both the position and displacement speed of the pin valve with maximum precision and accuracy by means of the electronic control unit.

During operation, a failure of the mains power supply may occur while one or more pin valves is in a partial or full opening position, thus leading to problems and drawbacks both regarding the molding cycle in progress and the subsequent cycles following the restoration of the mains power supply. These problems may lead to discarding not only the piece being molded but also the pieces molded subsequently, in that the cooling and solidification of the plastic material in non-designated areas in the nozzle/s may generate residual material to the detriment of the aesthetic quality of the first molding operations subsequent to the reactivation of the apparatus.

### SUMMARY OF THE INVENTION

The object of the present invention is to overcome the aforementioned drawbacks, and this object is mainly attained by means of a management method as defined in the pre-characterizing part of claim 1, whose main characteristic lies in the fact that it provides for the steps of providing an auxiliary power supply and configuring the electronic control unit so as to activate an emergency control, due to which the pin valve of the injector is positioned in said full closure position by means of said auxiliary power supply, in case of failure of the mains power supply.

Thus, the auxiliary power supply, typically constituted by a battery-powered uninterrupted power supply, allows guaranteeing the operation of the apparatus in a given period of time subsequent to possible main power supply failure. This additional time allows the control unit to send the full closure command to the actuator of the pin valve, so as to avoid the problems that could arise should the pin valve stop in a partial or full opening position. If the actuator consists in an electric motor, the operation thereof to attain the closure of the pin valve shall be guaranteed by the auxiliary power supply.

Should the molding apparatus use a hydraulic-type press, the emergency command may also stop the hydraulic press so as to stop the supply of plastic material to the or to each injector. Obviously, this option is not necessary in case of electrical actuation presses, in which case the stopping occurs automatically in case of electrical power failure.

The press may also be stopped manually by the operator in case of occurrence of hazardous conditions. This interruption usually occurs by pressing a safety button: According to a further characteristic of the invention, the emergency command actuated by the electronic control unit to displace the or each pin. valve to the full closure position is also actuated in case of voluntary deactivation of the press by means of such safety button.

In cases where the molding apparatus includes a plurality of injectors whose pin valves are actuated according to one or more preset cycles, the emergency command operates in a manner such to promptly displace the pin valves of all the injectors to the respective full closure positions, regardless of the preset cycle.

The invention also regards the injection molding apparatus.

### BRIEF DESCRIPTION OF THE DRAWINGS

The invention will now be described in detail, purely by way of non-limiting example, with reference to the attached drawings, wherein:

FIG. 1 schematically shows, and in partial section, a part of an injection molding apparatus that operates according to the invention, represented in the normal operating condition, and

FIG. 2 is a view analogous to FIG. 1 showing the apparatus in the emergency operating mode.

### DETAILED DESCRIPTION OF THE INVENTION

The figures schematically show a part of the apparatus for the injection molding of plastic materials comprising an injector 3 connected to a molten plastic material distributor or hot chamber 2 and comprises a nozzle 5 provided, at the free end thereof, with a nozzle terminal 6 in communication with the cavity of a mold S through an injection gate. The plastic material is supplied to the not chamber 2 by a conventional press, of the hydraulic or electrical actuation type, neither illustrated nor described in detail in that of the conventional type.

The flow of the plastic material through the nozzle terminal 6 is controlled by a pin valve 7 axially displaceable along the nozzle 5 by means of an actuator 8, between a full closure lowered position represented in the figure, and a maximum opening raised position.

In the case of the illustrated. example, the actuator is, by way of non-limiting example, of the electrical type and more in particular it consists in a rotary electric motor: the arrangement thereof represented in the figure is given purely by way of example. The shaft of the rotary electric motor drives the pin valve 7 usually through a transmission of the reversible type including a screw dive group and an oscillating lever, not represented, for example in a manner similar to that described and illustrated in the aforementioned document EP-2679374A1.

The electric motor 8 is operatively connected to an electronic control unit 4 configured to actuate the pin valve 7 according to preset cycles, as a function of various parameters. in particular, the electronic unit 4 is programmed to actuate the pin valve 7 in a controlled manner position-wise and possibly also speed-wise during the opening and closure of the injector 3.

The actuator of the injector could also be of the fluid, hydraulic or pneumatic type, and in this case, the electronic control unit 4 controls the relative control solenoid valves thereof.

Going back to the example described herein, it should be observed that the molding apparatus may include a plurality of injectors 3 similar to the one described, each provided with a respective electric motor 8 connected to the electronic control unit 4 which is programmed to actuate the various injectors according to sequential or cascade cycles in this case.

The or each electric motor 8 and the electronic control unit 4 are connected to the power supply mains M through the circuit illustrated in the figures, comprising a battery-powered uninterrupted power supply 9 and an exchange switch, schematized with 10. The uninterrupted power supply 9 is provided for power supplying and guaranteeing the operation of the motor 8 and the electronic control unit 4 at least over a determined period of time subsequent to a possible failure of the mains power supply M.

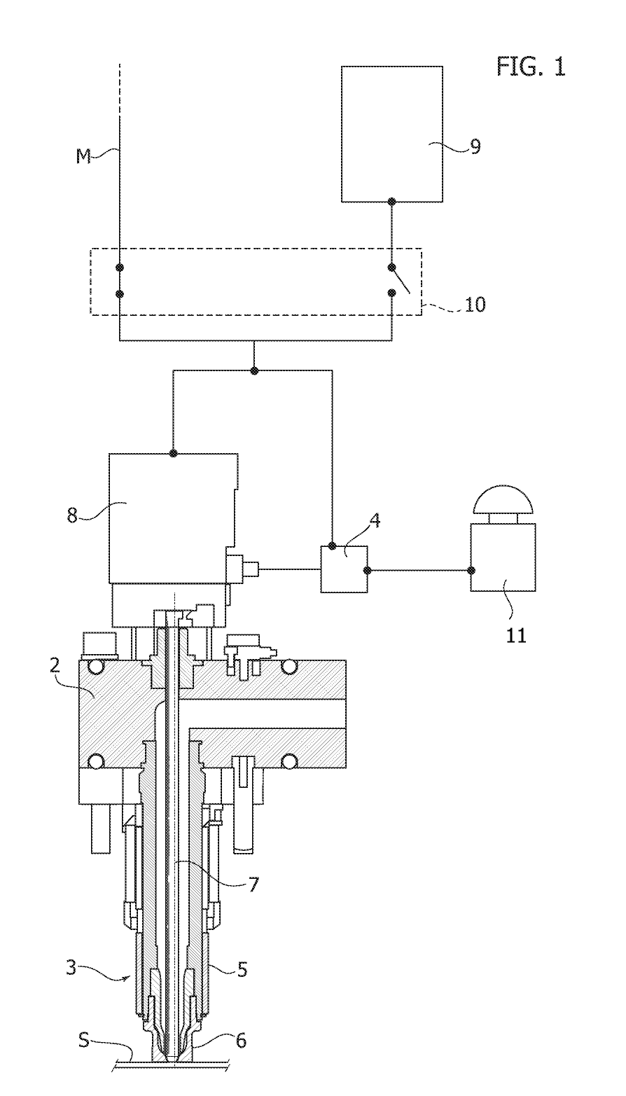

FIG. 1 represents the condition of normal operation of the apparatus, wherein the exchange switch 10 connects the electronic control unit 4 and the electric motor 8 to the mains M.

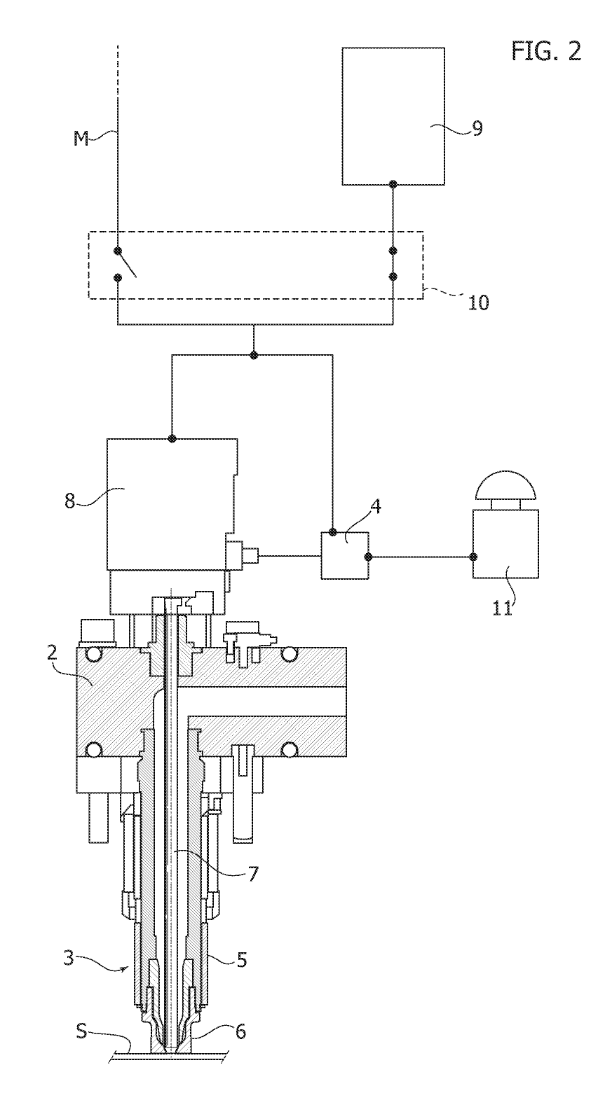

According to the invention, the electronic control unit 4 is configured so that it automatically and promptly switches the exchange switch 10 to the position represented in FIG. 2, in which the electric motor 8 is supplied by the uninterrupted power supply 9 in case of failure of the mains power supply M. This allows guaranteeing the operation of the electric motor 8, and thus the injector 3, for a determined period of time subsequent to the main power supply failure.

The electronic control unit 4 is configured or programmed to automatically activate, upon such switching, an emergency command due to which the electric motor 8 actuated by the uninterrupted power supply 9 promptly arranges the pin valve 7 in the full closure position regardless of the current position and speed thereof. This allows avoiding the problems and drawbacks that could occur, should the pin valve 7 stop in a partial or full opening position, both during the molding cycle in progress and in the subsequent cycles following the restoration of the mains power supply M.

In case of an actuator or actuators of the fluid type, the uninterrupted power supply 9 shall power supply the relative solenoid valves to attain the same result, through the electronic unit 4.

Should the molding apparatus use a hydraulic-type press, the emergency command generated by the electronic control unit 4 may also stop the hydraulic press so as to stop the supply of plastic material to the injector 3 in case of failure of the mains power supply M.

Both in case of hydraulic and electric presses, a safety button 11 is normally provided for so as to be manually actuated by the operator with the aim of voluntarily deactivating the press at any time. In this case, the emergency command actuated by the electronic control unit 4, and due to which the pin. valve 7 is immediately displaced to the closure position, may also be generated following the actuation of the safety button 11. This function is actuated by the electronic control unit 4 regardless of failure of the mains power supply, i.e. even in normal power supply conditions by the mains 14, and without requiring switching the exchange switch 10 for the use of the uninterrupted power supply 9.

In cases where the molding apparatus includes a plurality of injectors 3 whose pin valves 7 are actuated by the respective actuators 8 by means of the electronic control unit 4 according to one or more preset cycles, the emergency command operates in a manner such to promptly displace the pin valves of all the injectors to the respective full closure positions, regardless of the preset cycle.

Obviously, the construction details and the embodiments of the molding apparatus may widely vary with respect to what has been described and illustrated, without departing from the scope of protection of the present invention as described in the claims that follow.

1. A method for managing a molding apparatus for the injection molding of plastic materials comprising at least one injector including a pin valve displaceable between a fully closed position and an open position of the at least one injector, an actuator for operating the pin valve of the at least one injector, and an electronic control unit of the actuator, wherein operation of the actuator and/or of the electronic control unit is provided by a mains power supply, wherein the method includes providing an auxiliary power supply and configuring said electronic control unit so as to operate, in case of failure of the mains power supply, an emergency command by virtue of which the pin valve of the at least one injector is positioned in said fully closed position by said auxiliary power supply.

2. The method according to claim 1, wherein the molding apparatus includes a hydraulic-type press for feeding the plastic material to said at least one injector, and wherein said emergency command also stops the hydraulic-type press.

3. The method according to claim 1, wherein the molding apparatus includes a press for feeding the plastic material to said at least one injector, and wherein said emergency command is operated also in case of voluntary deactivation of said press, regardless of any failure of the mains power supply.

4. The method according to claim 1, wherein the molding apparatus comprises a plurality of injectors whose pin valves are driven according to one or more pre-set cycles, wherein said emergency command acts so as to displace the pin valves of all of the plurality of injectors to the respective fully closed positions regardless of the pre-set cycle.

5. The method according to claim 1, wherein said actuator is an electric motor fed by the auxiliary power supply in case of failure of the mains power supply.

6. An apparatus for the injection molding of plastic materials comprising at least one injector including a pin valve displaceable between a fully closed position and an open position of the at least one injector, an actuator for operating the pin valve of the at least one injector, and an electronic control unit of the actuator, wherein operation of the actuator and/or of the electronic control unit is provided by a mains power supply, wherein the apparatus further comprises an auxiliary power supply and said electronic control unit is configured so as to operate, in case of failure of the mains power supply, an emergency command by virtue of which the pin valve of the at least one injector is positioned in said fully closed position by said auxiliary power supply.

7. The apparatus according to claim 6, comprising a hydraulic-type press for feeding the plastic material to said at least one injector, wherein said emergency command also stops the hydraulic press.

8. The apparatus according to claim 6, comprising a machine for feeding the plastic material to said at least one injector and also comprising a stop device for manually stopping the press, wherein said emergency command is operated also in case of activation of said stop device, regardless of any failure of the mains power supply.

9. The apparatus according to claim 6, wherein said actuator is an electric motor fed by the auxiliary power supply in case of failure of the mains power supply.

10. The apparatus according to claim 6, wherein the molding apparatus comprises a plurality of injectors whose pin valves are driven according to one or more pre-set cycles, wherein said emergency command acts so as to displace the pin valves of all of the plurality of injectors to the respective fully closed positions regardless of the pre-set cycle.
